(19) United States
(12) Patent Application Publication
(10) Pub. No.: US 2017/0164811 A1
(43) Pub. Date: Jun. 15, 2017

(54) WAREWASH MACHINE WITH DESCALING/DELIMING SYSTEM AND METHOD

(71) Applicant: Premark FEG L.L.C., Glenview, IL (US)

(72) Inventors: Alexander R. Anim-Mensah, Centerville, OH (US); Jeffrey R. Newcomer, Troy, OH (US); Brian A. Brunswick, Tipp City, OH (US)

(21) Appl. No.: 15/441,933

(22) Filed: Feb. 24, 2017

Related U.S. Application Data
(62) Division of application No. 13/826,962, filed on Mar. 14, 2013.
(60) Provisional application No. 61/691,590, filed on Aug. 21, 2012.

(51) Int. Cl. A47L 15/00; A47L 15/42; A47L 15/46; B08B 9/093

(52) U.S. Cl. CPC A47L 15/0057; B08B 9/093; A47L 15/4297; A47L 15/46; B08B 2203/007; A47L 2401/11; A47L 2401/22; A47L 2501/34

(57) ABSTRACT

The timing of warewash machine delime operations may be set according to one or more of water used in the machine or one or more machine characteristics. A delime process that utilizes intermittent shock delime operations is also provided.

### CROSS-REFERENCES

This application claims the benefit of U.S. Provisional Application Ser. No. 61/691,590, filed Aug. 21, 2012, which is incorporated herein by reference.

### TECHNICAL FIELD

This application relates generally to the field of warewash machines that utilize delime operations and, more specifically, to a system and method adapted to delime according to condition of water input to the machine.

### BACKGROUND

On a stationary warewasher or dishwasher (e.g., a batch-type or box-type dishwasher), wash arms located on the top and bottom of the washing chamber wash wares located in a dish rack by directing a washing solution out of nozzles located on the arms. The sprayed washing solution is typically a recirculated solution that, once sprayed, falls and collects in a sump below the chamber, is drawn from the sump through a strainer by a pump and is pushed by the pump along a flow path into the wash arms and then out through the nozzles. One or more rotatable rinse arms may also be provided for spraying fresh rinse liquid. In a flaw-through warewasher (e.g., a continuous-type warewasher), wares are moved through a chamber (e.g., via a conveyor that moves racks of wares or via a conveyor with flights that hold wares) with multiple spray zones (e.g., a pre-wash zone, a wash zone, a post-wash or pre-rinse zone and a final rinse zone, each having respective nozzles) as they are cleaned.

Regardless of machine type, over time, lime and/or scale deposits build up. The scales in the booster heater are formed from the water alone while the scales of the wash zone are formed from water and/or chemicals added to the water such as detergents, rinse aid, etc. It is desirable to timely remove such deposits through the use of a delime/descale operation in which a delime/descale chemical is delivered through the machine via the nozzles sprays.

### SUMMARY

The timing of warewash machine delime operations may be set according to water used in the machine and/or machine characteristics.

A delime process that utilizes intermittent shock delime operations is also provided.

In a first aspect, a method is provided for repeatedly deliming a warewash machine including a recirculated spray system for spraying liquid within a chamber of the machine. The method involves the steps of performing multiple delime operations over time, in which delime solution formed by water with added delime chemical is sprayed through nozzles of the recirculated spray system, including: (i) performing multiple successive normal delime operations at a normal delime chemical concentration; and (ii) after the multiple successive normal delime operations, performing a shock delime operation at a shock delime chemical concentration, where the shock delime chemical concentration is substantially higher than the normal delime chemical concentration.

In one implementation of the method, each of the multiple successive normal delime operations is performed on a timed basis and the shock delime operation is performed after a specified number of the normal delime operations.

In one implementation of the method, a time period between successive normal delime operations is set according to hardness of water being used in the machine, such that higher hardness of water results in a lower time period between successive normal delime operations.

In one implementation, the specified number of normal delime operations is set according to one or more of (i) hardness of water being used in the machine, with lower hardness of water tending to result in a lower specified number, or (ii) time period between normal delime operations, with longer time period between normal delime operations tending to result in a lower specified number.

In one implementation, the warewash machine includes a sensor for automatically evaluating the hardness of incoming water to the machine.

In one implementation, the shock delime concentration is set according to one or more of (i) hardness of water being used in the machine, with lower hardness of water tending to result in a higher shock delime concentration, or (ii) time period between normal delime operations, with longer time period between normal delime operations tending to result in a higher shock delime concentration.

In one implementation, during delime operations the delime chemical is delivered into a hot water booster of the machine before being initially sprayed into the machine.

In one implementation, during delime operations at least one of pH, conductivity or total dissolved solids in the delime solution is used to determine when to end the delime operation.

In one implementation, during delime operations delime chemical is added multiple times during the delime operation.

In a second aspect, a method is provided for setting up a warewash machine for delime operations, the warewash machine including a chamber with a recirculated spray system for spraying liquid within the chamber. The method involves the steps of identifying the hardness of water that will be used in the machine; and defining one or more of (i) a time period between delime operation alerts or (ii) a delime chemical concentration based at least in part upon the hardness of water, such that higher hardness of water results in one or more of (a) shorter time period between delime operation alerts, or (b) a higher delime chemical concentration used.

In one implementation of the second aspect, the warewash machine is a batch warewash machine and the time period is defined based upon both hardness of water and two or more of: identified number of cycles per unit time, identified number of fill-dump cycles per unit time, rinse water volume per cycle, tank volume or heater characteristic.

In one implementation of the second aspect, the warewash machine is a flow-through type machine and the time period is defined based upon both hardness of water and two or more of: identified rinse flow rate, identified rinse on time, identified number of fill-dump cycles per day, tank volume or heater characteristic.

In one implementation of the second aspect, the time period is defined based upon both hardness of water and heater characteristic of the machine.

In one implementation of the second aspect, the time period is defined based upon each of hardness of water, heater characteristic and volume of water used in the machine over time.

In one implementation of the second aspect, the heater characteristic is defined by one or more of number of heating elements, heating element watt density, heating element material or heating element surface finish.

In one implementation of the second aspect, the heater characteristic is defined based at least in part upon test data for the type of machine being set up.

In one implementation of the second aspect, the warewash machine includes a controller configured to automatically define one or both of the time period or delime chemical concentration based upon one or more data input via a user interface of the machine.

In one implementation of the second aspect, the warewash machine includes a controller configured to automatically define one or both of the time period or delime chemical concentration based upon water hardness indication provided by a water hardness sensor of the machine.

In one implementation of the second aspect, the controller occasionally reevaluates water hardness indication to adjust one or both of the time period or delime chemical concentration.

In one implementation of the second aspect, one or both of the time period or delime chemical concentration is predetermined external of the machine and then incorporated into control logic of a controller of the warewash machine.

In a third aspect, a method is provided for carrying out a warewash machine delime operation, the warewash machine including a chamber with a recirculated spray system for spraying liquid within the chamber and a rinse system for spraying rinse liquid in the chamber. The method involves the steps of: feeding delime chemical into a hot water booster of the machine to produce a delime solution of both water and delime chemical; and delivering the delime solution from the hot water booster into a chamber of the machine via spray nozzles of the rinse system of the machine.

One implementation of the third aspect, involves the further steps of heating the delime solution to a set temperature in the hot water booster; and the delivering step occurs only after the set temperature is reached.

One implementation of the third aspect involves the steps of: allowing the sprayed delime solution to collect in a sump or tank of the machine, without recirculation, for a defined time period; and after the set time period, recirculating the delime solution through the recirculated spray system of the machine that includes the sump or tank, a pump and spray nozzles.

One implementation of the third aspect involves the steps of: allowing the sprayed delime solution to collect in a sump or tank of the machine, without recirculation; while sprayed delime solution sits in the sump or tank, again feeding delime chemical to the hot water booster to create additional delime solution; delivering the additional delime solution from the hot water booster into the chamber via the spray nozzles; allowing the sprayed additional delime solution to collect in the sump or tank to produce final delime solution; and recirculating the final delime solution through the recirculated spray system of the machine that includes the sump or tank, a pump and spray nozzles.

One implementation of the third aspect involves the steps of: recirculating the delime solution through the recirculated spray system of the machine that includes a sump or tank, a pump and spray nozzles; and utilizing a heater in the sump or tank to maintain the delime solution at a desired temperature during the recirculation.

In a fourth aspect, a batch-type or flow-through type warewash machine includes a chamber for receiving wares to be washed, the chamber including spray nozzles for spraying liquid. The machine further includes a chemical flow path for feeding a delime chemical for deliming operations. A controller of the machine is configured to control components of the machine to carry out the method of any one or more the twenty-five preceding paragraphs.

The details of one or more embodiments arc set forth in the accompanying drawings and the description below. Other features, objects, and advantages will be apparent from the description and drawings, and from the claims.

### BRIEF DESCRIPTION OF THE DRAWINGS

FIG. 1 is schematic depiction of a batch-type warewasher;

FIG. 2 shows an exemplary graph of days to delime vs. water hardness in relation to Equations 1 and 2;

FIG. 3 shows an exemplary graph of days to delime vs. water hardness in relation to Equation 3;

FIG. 4 shows an exemplary graph of delime operation duration vs. delime solution concentration;

FIG. 5A shows an exemplary graph of delime solution conductivity vs. delime operation duration;

FIG. 5B shows an exemplary graph of delime solution pH vs. delime operation duration;

FIG. 6A shows another exemplary graph of delime solution conductivity vs. delime operation duration;

FIG. 6B shows another exemplary graph of delime solution pH vs. delime operation duration;

FIG. 7A shows another exemplary graph of delime solution conductivity vs. delime operation duration;

FIG. 7B shows another exemplary graph of delime solution pH vs. delime operation duration;

FIG. 8 shows an exemplary series of delime operations with shock delime operations spaced intermittently between success normal delime operations;

FIG. 9 shows an exemplary table of shock delime frequency for various water hardness values; and

FIG. 10 is a schematic depiction of a flow-through type machine.

### DETAILED DESCRIPTION

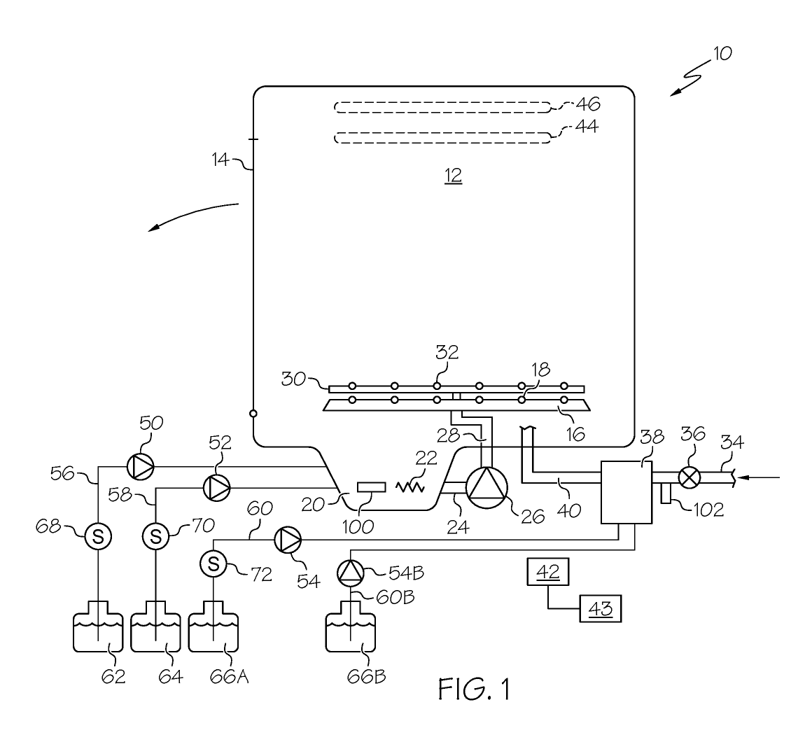

Referring to FIG. 1, a schematic depiction of a batch-type warewasher 10 is shown, and includes a chamber 12 in which wares are placed for cleaning via opening of a pivoting access door 14. At the bottom of the chamber 12, a rotatable wash arm 16 is provided and includes multiple nozzles 18 the eject wash liquid during a cleaning operation. The wash liquid contacts the wares for cleaning and then falls back down into a collection sump 20 that may include a heater element 22. A recirculation path is provided via piping 24, pump 26 and piping 28 to move the wash liquid back to the wash arm 16. A rotatable rinse arm 30 with nozzles 32 is also shown, to which fresh rinsing liquid may be fed via a rinse line made up of fresh water input line 34, valve 36, boiler 38 and line 40. A controller 42 is also shown, which may typically be programmed to carry out one or more selectable ware cleaning cycles that generally each include at least a washing step (e.g., that may run for 30-150 seconds, followed by a rinsing step (e.g., that may run for 10-30 seconds), though many other variations are possible. A user interface 43 is also associated with the controller for enabling operator selection of a ware cleaning cycle etc. Although the illustrated machine 10 includes only lower arms, such machines may also include upper wash and rinse arms shown schematically as 44 and 46. Such machines may also include other features, such as blowers for a drying step at the end of a ware cleaning cycle. Machines with hood type doors, as opposed to the illustrated pivoting door, are also known. Flow-through type machines are also known, as described above.

As shown in FIG. 1, the system includes a set of pumps 50, 52, 54A, 54B along respective feed lines 56, 58, 60A, 60B to deliver chemicals from supply bottles 62, 64, 66A, 66B. By way of example, bottles 62 and 64 may hold detergent and sanitizer respectively, which are selectively delivered into the machine sump 20, bottle 66A may hold rinse aid that is selectively delivered into the hot water booster or boiler 38 and bottle 66A may hold a delime chemical that is selectively delivered into the hot water booster or boiler 38. Each feed line 56, 58 and 60A includes a respective in-line chemical sensor 68, 70, 72 to detect whether chemical is passing along the feed line when the pump 50, 52, 54 is operating. The feed line 60B may include such a sensor as well, or the sensor may not be used (as shown) due to the caustic nature of the delime chemical. Feed lines 56 and 58 (e.g., for detergent and sanitizer respectively) are shown delivering chemical directly to the sump 20, but could alternatively be connected to feed chemical elsewhere in the chamber 12 or to a portion of the recirculation path 24, 26, 28. Feed line 60A (e.g., for rinse aid) is shown delivering the rinse aid directly to the hot water booster 38, but could alternatively deliver the rinse aid elsewhere into the rinse line, either upstream or downstream of the booster. Feed line 60B is shown delivering the delime chemical directly to the hot water booster 38, but could alternatively deliver the delime chemical elsewhere into the rinse line, either upstream or downstream of the booster, or into the sump 20 or elsewhere into the chamber.

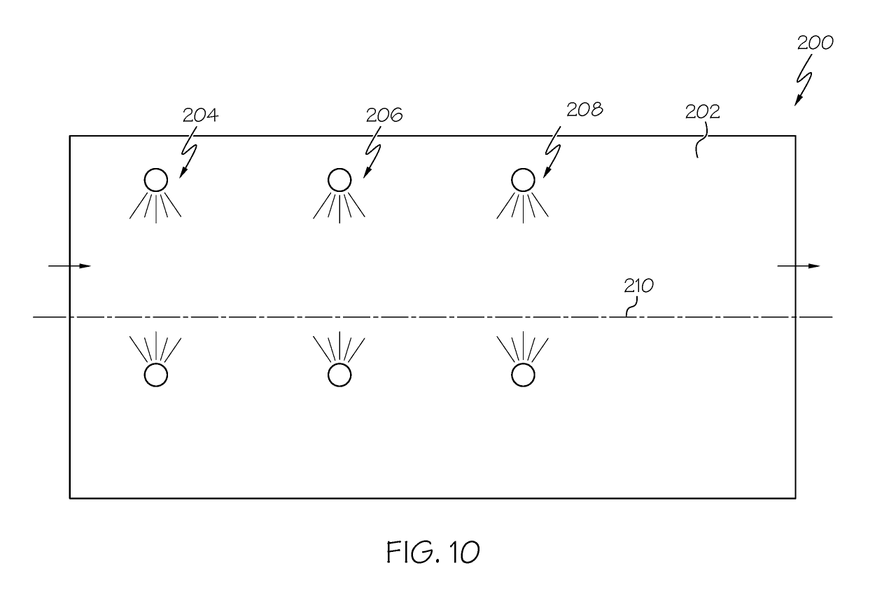

An exemplary flow-through type machine 200 is shown in FIG. 10, and includes a housing that defines an internal chamber 202 that includes multiple spray zones 204, 206 and 208, with a conveyor 210 to carry the wares through the zones for cleaning.

### Delime Setup

An advantageous method of setting up a warewash machine for delime operations is now described. The method involves identifying the hardness of water that will be used in the machine and defining one or both of (i) a time period between delime operation alerts and/or (ii) a delime chemical concentration based at least in part upon the hardness of water. Specifically, the time period is defined such that higher hardness of water results in (i) shorter time period between delime operation alerts and/or (ii) a higher delime chemical concentration used. As used herein, the term “and/or” when referring to multiple steps, structures or characteristics means

In one implementation, a service or install person may identify he water hardness by actual testing of the water at the install site, or by accessing preexisting data regarding water hardness of the install site, and inputting the water hardness into the machine via the machine interface. In another embodiment, the machine itself may have an in-line water hardness sensor 102 (e.g., such as the Hach SP-510 water hardness sensor or any other suitable existing or future water hardness sensor). At machine install, the controller may run through a set-up operation where the input water hardness is evaluated so that the controller automatically defines the days to delime and/or delime solution concentration. The controller may also be configured (e.g., programmed) to automatically occasionally (e.g., periodically or on specific dates or based upon run time) reevaluates the hardness of the input water to adjust the days to delime and/or delime solution concentration.

If the warewash machine is a batch warewash machine, the time period is defined based upon both hardness of water and two or more of identified number of cycles per unit time, identified number of fill-dump cycles per unit time, rinse water volume per cycle, tank volume and/or heater characteristic. Equation I described below provides an exemplary equation according to such factors.

If the warewash machine is a flow-through type machine, the time period is defined based upon both hardness of water and two or more of identified rinse flow rate, identified rinse on time, identified number of fill-dump cycles per day, tank volume and/or heater characteristic. Equation 2 described below provides an exemplary equation according to such factors.

Generally, in the case of both. Equations 1 and 2, the time period is defined based upon each of hardness of water, heater characteristic and volume of water used in the machine over time.

The time period is also defined based upon both hardness of water and heater characteristic of the machine, as in the case of Equation (1) for both batch and flow-through warewashers. Equations 1, 2 and 3 described below are all consistent with utilization of both such factors.

As a general rule, the heater characteristic is defined by number of heating elements, heating element wattage and/or heating element watt density (e.g., watts per unit surface area), heating element material and/or heating element surface finish. In large part, the heater characteristic reflects the tendency of the heater (e.g., heater 22 or the booster heater element) to scale up and the impact of such scaling on heater performance. The heater characteristic is defined based upon test data for the type of machine being set up (e.g., running tests over time).

In one implementation, the warewash machine includes a controller configured to automatically define the time period and/or delime chemical concentration based upon inputs provided via a user interface of the machine. For example, the user interface could enable the operator to input (e.g., using a set-up menu) the hardness of the water and the type of delime chemical used (e.g., pH level of delime chemical). More advanced systems could also enable the input of type of detergent, sanitizer and/or rinse aid. The machine controller then automatically determines the time period (e.g., per an equation or table) and/or the delime chemical concentration (e.g., per an equation or table). Where both normal and shock delime operations are used, as described below, both time periods and associated delime chemical concentrations may be determined by the controller.

In another implementation, the time period and/or delime chemical concentration may be predetermined and then incorporated into control logic of a controller of the warewash machine. For example, upon taking a machine order or upon machine set-up, manufacturing or service personnel may perform the necessary calculation external of the machine and then set the time period into the machine logic. Where both normal and shock delime operations are used, as described below, both time periods may be set.

Both laboratory and field information are used to develop correlations between the water characteristics machine properties, operations, machine operation cycles, operating times and other variables with/without detergents, rinse aid, etc based on the machine. The correlations in addition to the various deliming solution concentrations and deliming times are programmed into the machine for the total deliming processes.

The machines are categorized into two types based on the operating modes (i.e., batch or continuous/flow-through). Equations (1), (2) and (3) below show typical correlation between the various variables programmed into the machine after which the deliming processes automatically initiates based on water characteristics at a particular location for the various operation modes. Equations (1) and (2) automatically preset the Number of Days to Delime (D) for the machine, while Equation (3) presets the machine based on the total fill/rinse pump on-time (t) or Total Gallons Processed (G) to initiate the deliming process. Equations (1) and (2) are for batch and continuous machine operating modes, respectively, while Equation (3) can be used for both modes. The selection of which equation to incorporate into machine logic depends on parameter used to monitor the scale build up and the flexibility of the programming as well as if the machine is an existing or newly developed one.

The batch system model as shown by Equation (1) considers the cycles per day (Cd), the number of fill-dumps per day (F), the rinse water volume per cycle (R), the tank volume (T), total water hardness (H) and a predefined constant “k” that acts as the heater characteristic of the machine. “k” is obtained from both laboratory and field data and has the unit of grains and represents the characteristics of a particular machine based upon, for example, number of heating elements in the wash tank, wattage of the heating element, surface finish of heating element, heating element material, etc.

$$Days Before Delime ( D ) = \frac{1}{HCd} ( \frac{k - TH}{\frac{TF}{Cd} + R} ) \qquad ( 1 )$$

The continuous system model as shown by Equation (2) considers the rinse flow rate (Rf, in gpm), rinse on time per day (Rt), the number of fill-dumps per day (F), the tank volume (T), total water hardness (H) and a constant “k”. k″ is obtained from both laboratory and field data and has the unit of grains and represents the characteristics of a particular machine based upon, for example, number of heating elements in the wash tank, wattage of the heating element, surface finish of heating element, heating element material, etc.

$$Days before delime ( D ) = \frac{1}{H} ( \frac{k}{F . T + 60. Ri . Rt} ) \qquad ( 2 )$$

The total fill/rinse pump on-time (t) model of Equation (3) relates only the total water hardness (H)-grains/gal and the constant “k” (grains) to initiation the deliming processes. Again, “k” is obtained from both the lab and field data and is the same for each machine in Equations (1) and (2).

$$t ( s ) = \frac{12.77 k}{H} \qquad ( 3 )$$

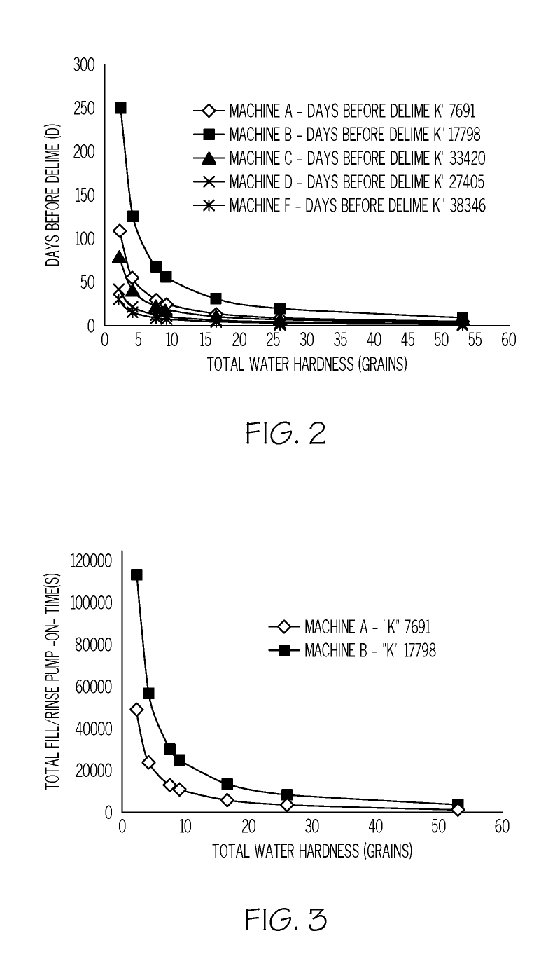

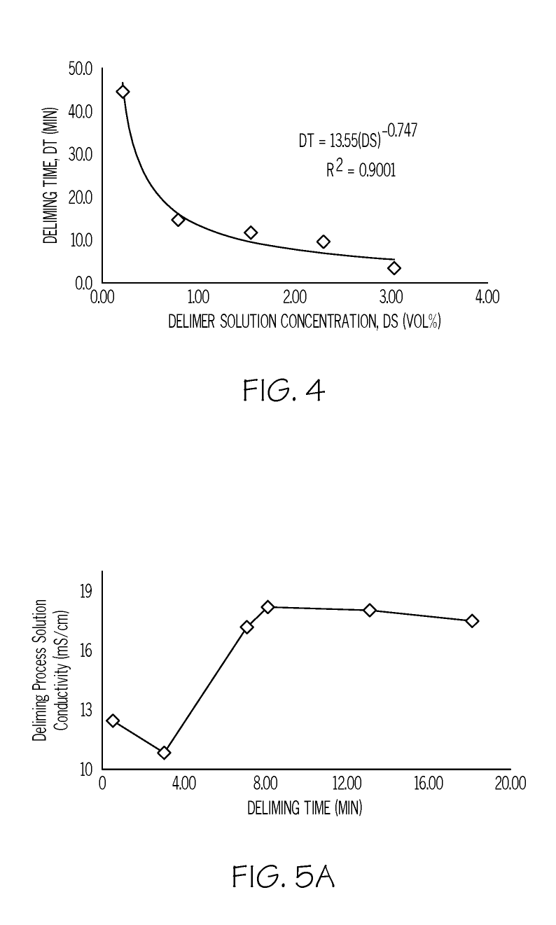

FIG. 2 shows a typical behavior of the days before delime (D) models with the total hardness for different machines using Equations (1) and (2). FIG. 3 shows typical behavior of the total fill/rinse pump on-time (t) model with total water hardness for two machines using Equation 3. FIG. 4 shows a typical plot of the deliming times (i.e., duration of the delime) for the various deliming solution concentrations for a particular delime chemical.

### General Delime Operations

Two implementations are contemplated based on system intelligence of interest.

In one implementation, across the board delime solution concentration, total delime time, shock delime frequency and shock delime concentration irrespective of water properties (e.g., total hardness, TDS, etc.). For example, all water hardness would use, for example, 1.4-1.6 volume % delime solution.

In another implementation (e.g., a “smarter” implementation), delime solution concentration, total delime time per delime operation, shock delime frequency and/or shock delime concentration may also be set based on water properties (e.g., total hardness, TDS, etc.). For example, for water hardness greater than 16 grains, 0.8-1.0 volume % delime solution may be used for the normal delime and for water hardness less than 16 grains, 1.4-1.6 volume % delime solution may be used.

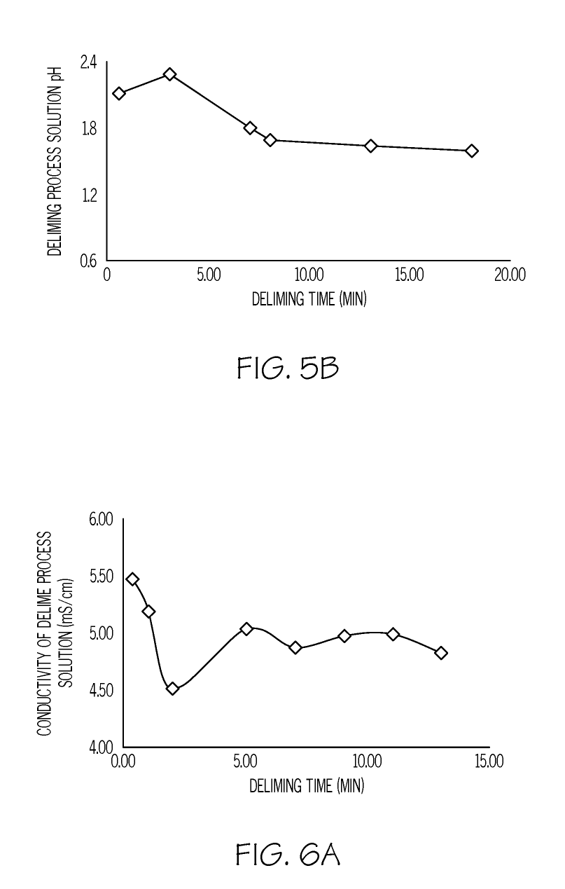

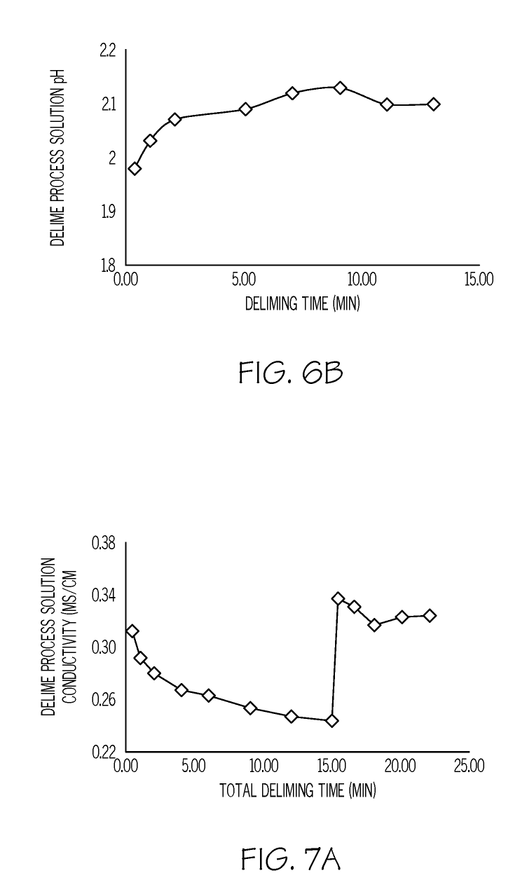

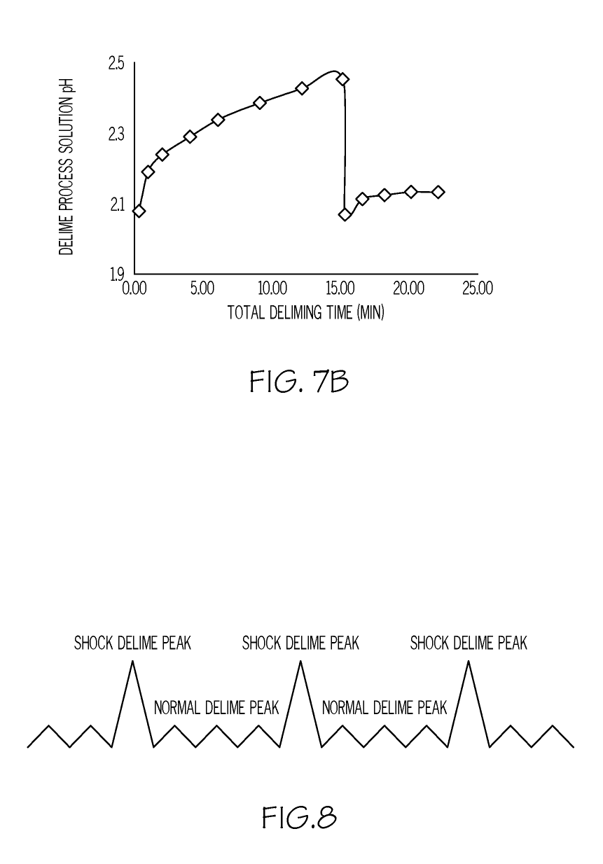

More intelligent systems may also monitor the delime operations through measurements of pH, TDS or conductivity to determine, for example, when to end a given delime operation and/or for controlling the addition of delime chemical, which may save chemicals and time while achieving the objective of effective scale removal. For this purpose, a pH, conductivity and/or total dissolved solids sensor(s) 100 (FIG. 1) may be positioned in the sump/tank of the machine. The controller would stop the delime operation when the monitored pH, conductivity and/or total dissolved solids in the delime solution crosses a set threshold (e.g., as may be determined by testing). FIGS. 5-7 show exemplary parameter variations as function of certain conditions. In particular, FIGS. 5A and 5B show conductivity vs. deliming time and solution pH vs. deliming time plots respectively for an exemplary deliming process where set amounts of delime chemical are dosed in defined intervals during the course of a deliming cycle. FIGS. 6A and 6B shows conductivity vs. deliming time and solution pH vs. deliming time plots respectively for a deliming process in which an amount of delime chemical is dosed once and deliming proceeds to the end of the delime operation. FIGS. 7A and 7B show conductivity vs. deliming time and solution pH vs. deliming time plots respectively for a deliming process involving two (2) delime cycles using low amounts of delime chemical once for each delime cycle of the operation.

In one method of carrying out a warewash machine delime operation, the method including the steps of: feeding delime chemical into a hot water booster of the machine to produce a delime solution of both water and delime chemical; and delivering the delime solution from the hot water booster into a chamber of the machine via spray nozzles of a rinse system of the machine. Feeding of the chemical into the booster provides for a more effective delime and also assures delime of the booster.

In one implementation, the delime solution may be heated to a set temperature in the hot water booster, and the step of delivering the delime solution occurs only after the set temperature is reached.

In another implementations, the sprayed delime solution may be allowed to collect in a sump or tank of the machine, without recirculation, for a defined time period. After the set time period, the delime solution is reciruclated through a spray recirculation system of the machine that includes the sump or tank, a pump and spray nozzles.

In yet another implementation, the sprayed delime solution is allowed to collect in a sump or tank of the machine, without recirculation. While sprayed delime solution sits in the sump or tank, delime chemical is again fed to the hot water booster to create additional delime solution. The additional delime solution is then delivered from the hot water booster into the chamber via the spray nozzles. The sprayed additional delime solution collects in the sump or tank to produce final delime solution. The final delime solution is recirculated through a spray recirculation system of the machine that includes the sump or tank, a pump and spray nozzles.

During any recirculating the delime solution through a spray recirculation system of the machine, a heater in the sump or tank may be used to maintain the delime solution at a desired temperature for effective delime.

In operation, the system prompts the operator to initiated delime based on the parameters described in, for example, one of Equations (1), (2) or (3). The operator, after shutting down or cessation of the normal operation of the machine, will press a knob or other input to initiate the delime operation. Part of the delime process involves a known amount of water and delime chemical to be input into the booster to form the required delime solution. The controller on the machine sends a signal to the heater to heat the solution to required temperature. The delime solution is then pumped from the booster to the wash zone. The booster is next filled with a similar delime solution, heated and pumped to the wash zone until the right volume or concentration after which the circulation of the delime solutions starts. During the delime process the tank heater will be activated as necessary to maintain required temperature.

The delime solutions circulation time for the delime operation may be preset based on the amount of delime chemical used or the delime chemical strength. After the delime operations is complete, the system drains out the delime solution from both the booster and wash zone. Residual delime solution is removed by rinsing the booster and wash zone at preset rinse volume, number of rinses and time before draining and placing the machine in service.

It is noted that the software development and arrangement allows capturing the actual and total delimer and water, used at any delime operation and over time, respectively.

### Shock Delime

In application, variation in the water type (i.e. type and concentration of ions), types of detergent and rinse aid, operators' reluctance to initiate the automatic deliming, etc could lead to residual scale build up which may be dealt with using an intermittent automatic shock delime concentration incorporated into the normal delime process as peaks (e.g., per FIG. 8). Each peak represents a delime operation, with normal delime operations carried out at a lower delime chemical concentration than the shock delime operations. In one implementation, the only difference between the shock and the normal delime process is the concentration which the shock is higher than the normal; and everything else is the same. The shock delime process may come on intermittently after a number of predetermined number of normal delime occasions.

Thus, a method of repeatedly deliming a warewash machine may involve the steps of performing multiple delime operations over time, in which delime solution formed by water with added delime chemical is sprayed through nozzles of a recirculated spray system of the machine, where the multiple delime operations include: (i) performing multiple successive normal delime operations at a normal delime chemical concentration; and (ii) after the multiple successive normal delime operations, performing a shock delime operation at a shock delime chemical concentration, where the shock delime chemical concentration is substantially higher than the normal delime chemical concentration.

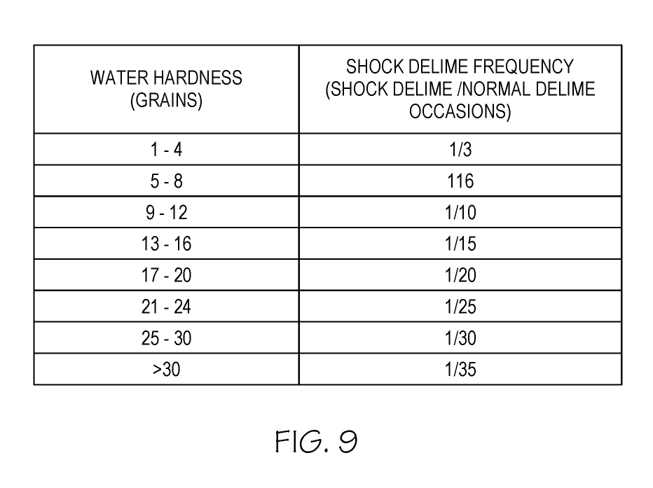

Each of the multiple successive normal delime operations may be performed on a timed basis and the shock delime operation may be performed after a specified number of the normal delime operations. As described above, a time period between successive normal delime operations may be set according to hardness of water being used in the machine, such that higher hardness of water results in a lower time period between successive normal delime operations. The specified number of normal delime operations between shock delimes may also be preset according to hardness of water being used in the machine and/or time period between normal delime operations, such that lower hardness of water and/or longer time period between normal delime operations results in a lower specified number. The reasoning behind this timing is that lower water hardness results in lower deliming frequency, but acceptable scales formed will be tougher because of the long time associated in forming acceptable scale. This fact requires a higher frequency of shock deliming process because of the higher possibility of scale residues and vice versa. The table in FIG. 9 shows an exemplary shock delime frequency per normal delime frequency variation with water hardness.

As noted, in certain implementations, the shock delime concentration is preset according to hardness of water being used in the machine and/or time period between normal delime operations, such that lower hardness of water and/or longer time period between normal delime operations results in a higher shock delime concentration.

Also, as shown in FIG. 1, during delime operations the delime chemical may be delivered into a hot water booster of the machine before being initially sprayed into the machine.

Two shock delime implementations are considered based on the system intelligence of interest.

In one implementations, across board shock delime solution concentration and shock delime frequency remains consistent irrespective of the water properties. For example, all shock concentrations are set at, say, 1.8 volume % delime solution.

In another implementation, shock delime solution concentration and shock delime frequency may be varied based on the water properties (e.g., total hardness, TDS, etc.). As mentioned above, lower water hardness results in acceptable scales in a longer time or lower delime frequency as compared with higher hardness water. However, the longer the time the tougher the scale formed to delime. So, for example, for a water hardness greater than 16 grains, a 1.4 volume % delime solution may be used, and for water hardness less than 16 grains, a 2.0 volume % delime solution may be used.

The operator should initiate the deliming process when prompted (e.g., via a message or light on the user interface). However, there is a possibility for the operator to skip the deliming process (e.g., the operator fails to activate the delime when alerted). The operator skipping the deliming process for some time period (e.g. through about 50% of the time period to next delime) may automatically initialize the shock deliming process for the next delime operation even if the next delime operation was previously set to be a normal delime. In effect, the shock delime is advanced out of turn due to the failure to timely effect the normal delime operation.

Possible advantages of certain implementations of the systems and methods described above include: (i) the capability to avoid use of a sensor to automatically predict acceptable scales formed in the machines and precisely initiate a complete machine descaling process effectively; (ii) the use of mathematical models (Equation 1 and 2 or 3) in conjunction with laboratory and field data to automatically initiate and delime a machine automatically; (iii) the capability to delime/descale a machine entirely, (iv) the capability to relate water properties to acceptable scale formation in a machine to initiate an automatic descaling process, (v) the capability for the machine to use shock delime concentrations and frequency as back up to ensure efficient and effective descaling/deliming processes, (vi) providing a refined way to effectively reduce misuse of delimers and (vii) capability to monitor and determine the actual and total delimer used at any delime operation and over time. However, it is recognized that implementations without one or more of the above advantages exist.

it is to be clearly understood that the above description is intended by way of illustration and example only, is not intended to be taken by way of limitation, and that other changes and modifications are possible. For example, while the foregoing description is made primarily in the context of a batch-type warewasher, it is contemplated that the devices and methods could also be implemented in a conveyor-type warewasher (e.g., a warewasher in which wares are conveyed through a chamber that has a series of spray zones). Moreover, while the delivery of delime chemical into a hot water booster is primarily contemplated, it is recognized that cold water machines without hot water boosters exist, and that in such machines the delime chemical would not be delivered into the hot water booster. By way of example, the delime chemical could be delivered into a chamber vent component of the cold water machine.

What is claimed is:

1. A method of repeatedly deliming a warewash machine including a recirculated spray system for spraying liquid within a chamber of the machine, the method comprising the steps of:
performing multiple delime operations over time, in which delime solution formed by water with added delime chemical is sprayed through nozzles of the recirculated spray system, including:
(i) performing multiple successive normal delime operations at a normal delime chemical concentration; and
(ii) after the multiple successive normal delime operations, performing a shock delime operation at a shock delime chemical concentration, where the shock delime chemical concentration is substantially higher than the normal delime chemical concentration.

2. The method of claim 1 wherein the each of the multiple successive normal delime operations is performed on a timed basis and the shock delime operation is performed after a specified number of the normal delime operations.

3. The method of claim 2 wherein a time period between successive normal delime operations is set according to hardness of water being used in the machine, such that higher hardness of water results in a lower time period between successive normal delime operations.

4. The method of claim 3 wherein the specified number of normal delime operations is set according to one or more of (i) hardness of water being used in the machine, with lower hardness of water tending to result in a lower specified number, or (ii) time period between normal delime operations, with longer time period between normal delime operations tending to result in a lower specified number.

5. (canceled)

6. The method of claim 2 wherein the shock delime concentration is set according to one or more of (i) hardness of water being used in the machine, with lower hardness of water tending to result in a higher shock delime concentration, or (ii) time period between normal delime operations, with longer time period between normal delime operations tending to result in a higher shock delime concentration.

7-9. (canceled)

10. A method of setting up a warewash machine for delime operations, the warewash machine including a chamber with a recirculated spray system for spraying liquid within the chamber, the method comprising the steps of:
identifying the hardness of water that will be used in the machine;
defining one or more of (i) a time period between delime operation alerts or (ii) a delime chemical concentration based at least in part upon the hardness of water, such that higher hardness of water results in one or more of (a) shorter time period between delime operation alerts, or (b) a higher delime chemical concentration used.

11. The method of claim 10 wherein the warewash machine is a batch warewash machine and the time period is defined based upon both hardness of water and two or more of: identified number of cycles per unit time, identified number of fill-dump cycles per unit time, rinse water volume per cycle, tank volume or heater characteristic.

12. The method of claim 10 wherein the warewash machine is a flow-through type machine and the time period is defined based upon both hardness of water and two or more of: identified rinse flow rate, identified rinse on time, identified number of fill-dump cycles per day, tank volume or heater characteristic.

13. The method of claim 10 wherein the time period is defined based upon both hardness of water and heater characteristic of the machine.

14. The method of claim 13 wherein the time period is defined based upon each of hardness of water, heater characteristic and volume of water used in the machine over time.

15. The method of claim 13 wherein the heater characteristic is defined by one or more of number of heating elements, heating element watt density, heating element material or heating element surface finish.

16. The method of claim 13 wherein the heater characteristic is defined based at least in part upon test data for the type of machine being set up.

17. The method of claim 10 wherein the warewash machine includes a controller configured to automatically define one or both of the time period or delime chemical concentration based upon one or more data input via a user interface of the machine.

18. The method of claim 10 wherein the warewash machine includes a controller configured to automatically define one or both of the time period or delime chemical concentration based upon water hardness indication provided by a water hardness sensor of the machine.

19. The method of claim 18 wherein the controller occasionally reevaluates water hardness indication to adjust one or both of the time period or delime chemical concentration.

20. The method of claim 10 wherein one or both of the time period or delime chemical concentration is predetermined external of the machine and then incorporated into control logic of a controller of the warewash machine.

21-25. (canceled)

26. A method of setting up a warewash machine for delime operations, the warewash machine including a chamber with a recirculated spray system for spraying liquid within the chamber, the method comprising the steps of:
identifying a water hardness of water that will be used in the machine;
establishing a timing for delime operation alerts based at least in part upon the identified water hardness, such that higher identified water hardness results in more frequent delime operation alerts.

27. The method of claim 26, further comprising:
defining a delime chemical concentration, for use during delime operations, based at least in part upon the identified water hardness, such that higher identified water hardness results in higher defined delime chemical concentration.

28. The method of claim 10 wherein the timing is established based upon both identified water hardness and heater characteristic of the machine.

29. The method of claim 13 wherein the timing is defined based upon each of identified water hardness of water, heater characteristic of the machine and volume of water used in the machine over time.
